(19) United States
(12) Patent Application Publication
(10) Pub. No.: US 2025/0322124 A1
(43) Pub. Date: Oct. 16, 2025

(54) INITIAL DESIGN GENERATION FOR OPTIMIZATION OF PHYSICAL STRUCTURES

(71) Applicant: Autodesk, Inc., San Francisco, CA (US)

(72) Inventors: Nigel Jed Wesley Morris, Toronto (CA); Massimiliano Meneghin, Tambre (IT); Hesam Salehipour, Richmond Hill (CA)

(21) Appl. No.: 18/637,214

(22) Filed: Apr. 16, 2024

(51) Int. Cl. G06F 30/28; G06F 113/08

(52) U.S. Cl. CPC G06F 30/28; G06F 2113/08

(57) ABSTRACT

Methods, systems, and apparatus, including medium-encoded computer program products include: obtaining a design space and one or more design criteria for a modeled fluid domain; performing a laminar fluid flow simulation for a fluid in the modeled fluid domain, thereby producing a velocity field of the fluid in the modeled fluid domain; generating a first three-dimensional shape of the modeled fluid domain, wherein generating the first three-dimensional shape includes excluding from the modeled fluid domain portions with absolute values of the obtained velocity field below a threshold value; providing the first three-dimensional shape to an iterative shape synthesis process that modifies at least a shape geometry of the fluid domain in accordance with the one or more design criteria to obtain a second three-dimensional shape of the modeled fluid domain; and providing the second three-dimensional shape of the modeled fluid domain for use in manufacturing.

### BACKGROUND

This specification relates to computer aided design of physical structures, which can be manufactured using additive manufacturing, subtractive manufacturing and/or other manufacturing systems and techniques, or other structures, which can be provided as a digital asset, such as for use in animation.

Computer Aided Design (CAD) software has been developed and used to generate three-dimensional (3D) representations of objects, and Computer Aided Manufacturing (CAM) software has been developed and used to evaluate, plan and control the manufacture of the physical structures of those objects, e.g., using Computer Numerical Control (CNC) manufacturing techniques. Typically, CAD software stores the 3D representations of the geometry of the objects being modeled using a boundary representation (B-Rep) format. A B-Rep model is a set of connected surface elements specifying boundaries between a solid portion and a non-solid portion of the modeled 3D object. In a B-Rep model (often referred to as a B-Rep), geometry is stored in the computer using smooth and precise mathematical surfaces, in contrast to the discrete and approximate surfaces of a mesh model, which can be difficult to work with in a CAD program.

CAD programs have been used in conjunction with subtractive manufacturing systems and techniques. Subtractive manufacturing refers to any manufacturing process where 3D objects are created from stock material (generally a “blank” or “workpiece” that is larger than the 3D object) by cutting away portions of the stock material. Such manufacturing processes typically involve the use of multiple CNC machine cutting tools in a series of operations, starting with a roughing operation, an optional semi-finishing operation, and a finishing operation. In addition to CNC machining, other subtractive manufacturing techniques include electrode discharge machining, chemical machining, waterjet machining, etc. CAD programs have also been used in conjunction with additive manufacturing systems and techniques. Additive manufacturing, also known as solid free form fabrication or 3D printing, refers to any manufacturing process where 3D objects are built up from raw material (generally powders, liquids, suspensions, or molten solids) in a series of layers or cross-sections. Examples of additive manufacturing include Fused Filament Fabrication (FFF) and Selective Laser Sintering (SLS). Other manufacturing techniques for building 3D objects from raw materials include casting and forging (both hot and cold) and molding.

In addition, CAD software has been designed to perform automatic generation of 3D geometry of one or more parts in a design of a fluid domain for which a physical structure is to be generated (known as “shape synthesis”, “topology optimization”, “generative design”, or “generative modelling”, among others). This automated generation of 3D geometry often works within a “design domain” specified by a user or the CAD software and generates geometry typically by optimizing design objectives and optionally respecting design constraints, which can be defined by the user, CAD software, or a third party. When the physical structure corresponds to a physical structure that surrounds a fluid domain and that is typically used for fluid flow or fluid control, such as a pipe, a hose, a valve, a pump, and/or a hydraulic manifold, some design objectives can be directed to the optimization of the fluid domain and include but are not limited to minimizing pressure drop or energy dissipation, and are used to drive the topology optimization process towards better designs. Though not required, it is typical for a design objective to be rooted in a simulation of the design (fluid dynamic, thermal, electromagnetic, etc.) For example, for design objectives such as minimizing pressure drop or energy dissipation, fluid dynamics simulation of the design can be performed. Design constraints can include a variety of physical characteristics or behaviors that must be met in any generated design (requirements, either on individual parts or on the entire assembly, are also admissible); examples include fixed flow rate, fixed volume, etc.

Further, the geometric inputs to such a 3D geometry generation tool can include one or more user- or CAD system-provided “keep-in” regions (indicating regions of the design that are to be held fixed, such as inlet regions and/or outlet regions at a boundary of the physical structure (and hence of the fluid domain) where boundary conditions such as prescribed flow rates or velocities are applied) or “keep-out” regions (indicating volumetric or surface regions that should be free from the generated 3D geometry). In some cases, the topology optimization process takes place using a different representation of geometry than that employed by the CAD system. For example, a CAD system might use a boundary representation (“B-Rep”) while the geometry generation and optimization engine might employ a boundary-based representation (e.g., a level-set-based representation) or a density-based representation embedded in a voxel or tetrahedral mesh.

### SUMMARY

This specification describes technologies relating to computer-aided design of structures, such as three-dimensional physical structures. The systems and techniques described can be used to optimize the shape and topology of a three-dimensional physical structure and for computer-aided manufacturing of three-dimensional physical structures.

In general, one or more aspects of the subject matter described in this specification can be embodied in one or more methods (and also one or more non-transitory computer-readable mediums tangibly encoding a computer program operable to cause one or more processors to perform operations), including: obtaining, by a computer aided design program, a design space for a modeled fluid domain, for which a corresponding physical structure is to be manufactured, and one or more design criteria for the modeled fluid domain, wherein the fluid domain includes an inlet region and an outlet region; performing a laminar fluid flow simulation for a fluid in the modeled fluid domain, thereby producing a velocity field of the fluid in the modeled fluid domain; generating a first three-dimensional shape of the modeled fluid domain, wherein generating the first three-dimensional shape of the modeled fluid domain includes excluding from the modeled fluid domain portions of the fluid domain with absolute values of the obtained velocity field below a threshold value; providing the first three-dimensional shape of the modeled fluid domain to an iterative shape synthesis process that modifies at least a shape geometry of the fluid domain in accordance with the one or more design criteria to obtain a second three-dimensional shape of the modeled fluid domain; and providing, by the computer aided design program, the second three-dimensional shape of the modeled fluid domain for use in manufacturing the physical structure using one or more computer-controlled manufacturing systems.

One or more aspects of the subject matter described in this specification can also be embodied in one or more systems including one or more processors; and a computer-readable medium storing instructions that cause the one or more processors to perform operations including: obtaining, by a computer aided design program, a design space for a modeled fluid domain, for which a corresponding physical structure is to be manufactured, and one or more design criteria for the modeled fluid domain, wherein the fluid domain includes an inlet region and an outlet region; performing a laminar fluid flow simulation for a fluid in the modeled fluid domain, thereby producing a velocity field of the fluid in the modeled fluid domain; generating a first three-dimensional shape of the modeled fluid domain, wherein generating the first three-dimensional shape of the modeled fluid domain includes excluding from the modeled fluid domain portions of the fluid domain with absolute values of the obtained velocity field below a threshold value; providing the first three-dimensional shape of the modeled fluid domain to an iterative shape synthesis process that modifies at least a shape geometry of the fluid domain in accordance with the one or more design criteria to obtain a second three-dimensional shape of the modeled fluid domain; and providing, by the computer aided design program, the second three-dimensional shape of the modeled fluid domain for use in manufacturing the physical structure using one or more computer-controlled manufacturing systems.

Performing the laminar fluid flow simulation for the fluid in the modeled fluid domain can include setting values for one or more fluid parameters, such that the fluid flows under laminar flow. The one or more design criteria can include a target volume reduction for the second three-dimensional shape. The threshold value can be determined during the generating using a predetermined volume reduction cutoff based on the target volume reduction for the second three-dimensional shape. The threshold value can be a predetermined flow velocity cutoff.

The threshold value can be a first threshold value. The excluding can generate a first test three-dimensional shape. The generating can include excluding from the modelled fluid domain portions of the fluid domain with absolute values of the obtained velocity field below at least one second threshold value, thereby producing at least a second test three-dimensional shape. The method can include selecting one of the first test three-dimensional shape and the at least one second test three-dimensional shape as the first three-dimensional shape. The selecting can include performing a test fluid flow simulation for each of the first test shape and the at least one second test shape, and comparing results of the test fluid flow simulations against at least one performance design criterion to determine which of the first test shape and the at least one second test shape is selected as the first three-dimensional shape.

Performing the test fluid flow simulation can include setting i) a test flow rate or flow velocity at the inlet region of the fluid domain or ii) a test viscosity for the fluid, such that the fluid flows under turbulent flow. The at least one performance design criterion can include minimizing pressure drop or energy dissipation in the fluid domain. Excluding from the modeled fluid domain the portions of the fluid domain with absolute values of the obtained velocity field below a threshold value can include redefining the fluid domain using a zero-level set of a level-set function. The level-set function can be equal to a difference between the absolute values of the obtained velocity field and the threshold value.

The one or more design criteria can include minimizing pressure drop or energy dissipation in the fluid domain. The iterative shape synthesis process can include setting second values for the one or more fluid parameters, such that the fluid flows under turbulent flow, and iteratively modifying, by the computer aided design program, the first three-dimensional shape of the modeled fluid domain in the design space in accordance with the one or more design criteria, to obtain the second three dimensional-shape of the fluid domain. The iterative shape synthesis process can include a generative design process for topology optimization.

Particular embodiments of the subject matter described in this specification can be implemented to realize one or more of the following advantages. The described methods can be employed during shape and/or topology optimization of a fluid domain for which a physical structure is to be manufactured (e.g., for automatically generating at least a portion of a physical structure to be manufactured, such as a pipe, a hose, a valve, a pump, and/or a hydraulic manifold). The described methods can be employed to obtain an initial shape for the optimization of the fluid domain. The initial shape obtained by the described methods can facilitate the convergence of a shape and/or topology optimization method. The initial shape obtained by the described methods can make shape and/or topology optimization methods for fluid domains for turbulent flows converge faster, reducing time to convergence and also processing power. Further, the described methods can also produce better designs for the fluid domain for which a physical structure is to be manufactured. The resulting shapes/topologies satisfy predetermined objectives such as designs that minimize pressure drop or energy dissipation and achieve levels of optimization that cannot be reached by standard methods. This can in turn facilitate construction of the physical structure.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example of a system usable to facilitate computer aided design and manufacturing of structures.

FIG. 2 is a flowchart of an example of a process for shape and/or topology optimization.

FIGS. 3A-3B show examples of different stages of a process for topology optimization according to techniques described in this document in comparison to corresponding stages of a standard process for topology optimization.

FIG. 4 is a schematic diagram of an example of a process for shape and/or topology optimization.

FIG. 5 is a schematic diagram of a data processing system including a data processing apparatus, which can be programmed as a client or as a server, and implement the techniques described in this document.

Like reference numbers and designations in the various drawings indicate like elements.

### DETAILED DESCRIPTION

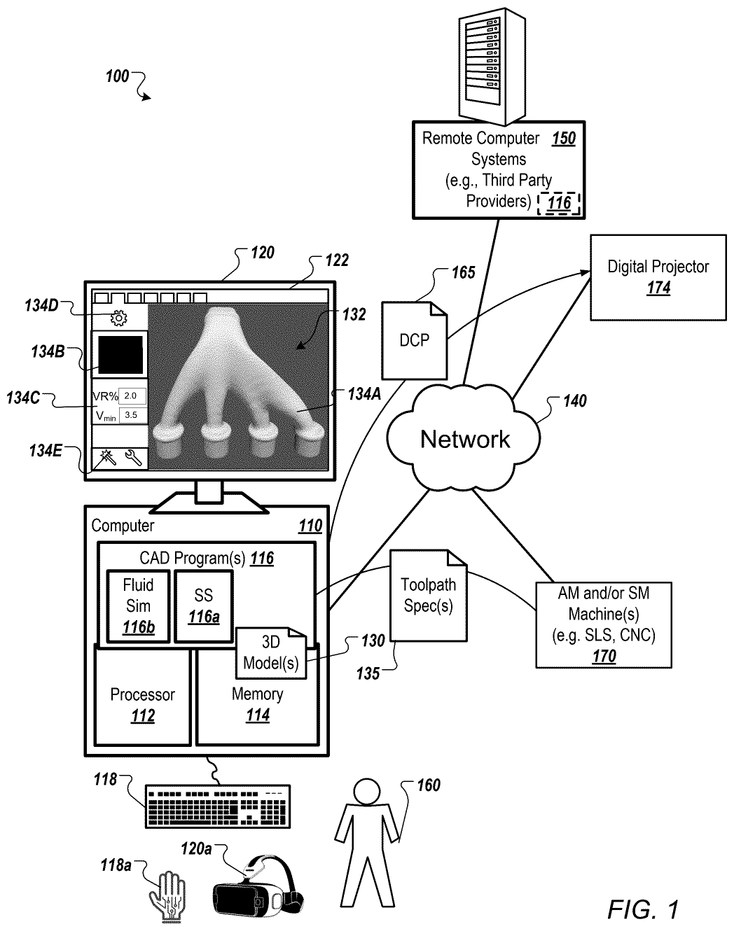

FIG. 1 shows an example of a system 100 usable to facilitate computer aided design and manufacturing of physical structures such as fluid system components. A computer 110 includes a processor 112 and a memory 114, and the computer 110 can be connected to a network 140, which can be a private network, a public network, a virtual private network, etc. The processor 112 can be one or more hardware processors, which can each include multiple processor cores. The memory 114 can include both volatile and nonvolatile memory, such as Random Access Memory (RAM) and Flash RAM. The computer 110 can include various types of computer storage media and devices, which can include the memory 114, to store instructions of programs that run on the processor 112, including Computer Aided Design (CAD) program(s) 116, which implement three-dimensional (3D) modelling functions and include a shape synthesis program 116a. For example, shape synthesis program 116a can implement a shape synthesis process such as an iterative shape synthesis process that modifies shape geometry and optionally both shape geometry and topology of a modeled object. Shape synthesis processes include automated modeling and generative design processes, including topology optimization processes. A numerical fluid simulation program 116b can also be included.

In some instances, the numerical simulation performed by the systems and techniques described in this document can simulate one or more physical properties and can use one or more types of simulation to produce a numerical assessment of a physical response (e.g., structural response) of the modeled object. For example, finite element analysis (FEA), including linear static FEA, finite difference method(s), and material point method(s) can be used. Further, the simulation of physical properties can include Computational Fluid Dynamics (CFD), Acoustics/Noise Control, thermal conduction, computational injection molding, electric or electro-magnetic flux, and/or material solidification (which is useful for phase changes in molding processes) simulations.

As used herein, CAD refers to any suitable program used to design physical structures that meet design requirements, regardless of whether or not the program is capable of interfacing with and/or controlling manufacturing equipment. Thus, CAD program(s) 116 can include Computer Aided Engineering (CAE) program(s), Computer Aided Manufacturing (CAM) program(s), etc. The program(s) 116 can run locally on computer 110, remotely on a computer of one or more remote computer systems 150 (e.g., one or more third party providers' one or more server systems accessible by the computer 110 via the network 140) or both locally and remotely. Thus, a CAD program 116 can be two or more programs that operate cooperatively on two or more separate computer processors in that one or more programs 116 operating locally at computer 110 can offload processing operations (e.g., geometry generation and/or physical simulation operations) “to the cloud” by having one or more programs 116 on one or more computers 150 perform the offloaded processing operations. In some implementations, all geometry generation operations are run by one or more programs in the cloud and not in a geometry representation modeler (e.g., B-Rep modeler) that runs on the local computer. Moreover, in some implementations, the geometry generation program(s) can be run in the cloud from an Application Program Interface (API) that is called by a program, without user input through a graphical user interface.

The CAD program(s) 116 present a user interface (UI) 122 on a display device 120 of the computer 110, which can be operated using one or more input devices 118 of the computer 110 (e.g., keyboard and mouse). Note that while shown as separate devices in FIG. 1A, the display device 120 and/or input devices 118 can also be integrated with each other and/or with the computer 110, such as in a tablet computer (e.g., a touch screen can be an input/output device 118, 120). Moreover, the computer 110 can include or be part of a virtual reality (VR) and/or augmented reality (AR) system. For example, the input/output devices 118, and 120 can include VR/AR input controllers, gloves, or other hand manipulating tools 118a, and/or a VR/AR headset 120a. In some instances, the input/output devices can include hand-tracking devices that are based on sensors that track movement and recreate interaction as if performed with a physical input device. In some implementations, VR and/or AR devices can be standalone devices that may not need to be connected to the computer 110. The VR and/or AR devices can be standalone devices that have processing capabilities and/or an integrated computer such as the computer 110, for example, with input/output hardware components such as controllers, sensors, detectors, etc.

In any case, a user 160 interacts with the CAD program(s) 116 to generate and/or optimize 3D model(s), which can be stored in model document(s) 130. In the example shown in FIG. 1, a 3D model 132 includes geometry 134A that has been automatically generated using a process that employs systems and techniques described in this document. The topology generation process can receive an initial 3D design space as input.

In some implementations, the user 160 can define a shape and/or topology optimization problem to produce a desired 3D model from a starting domain. In general, the input design space can be automatically generated or user specified.

The CAD program(s) 116 can implement at least one fluid simulation process 116b, such as a laminar fluid flow simulation process. The velocity field resulting from the laminar fluid flow simulation process can be used to determine a three-dimensional shape for the fluid domain that can be used as a starting shape for a shape and/or topology optimization program 116a to obtain an optimized three-dimensional shape for the fluid domain for which a corresponding physical structure is to be manufactured, such as an optimized pipe, a hose, a valve, a pump, and/or a hydraulic manifold, which enables the CAD program(s) 116 to generate the 3D model(s) automatically based on design objective(s) (e.g., minimization of pressure drop or energy dissipation) and constraint(s), i.e., design criteria, where the geometric design can be iteratively optimized based on simulation feedback (e.g., based on a numerical, physics simulation). In some instances, multiple 3D models can be co-created by one or more shape synthesis processes (e.g., generative design processes) and can be assembled to form a new 3D model. Note that, as used herein, “optimization” (or “optimum”) does not mean that the best of all possible designs is achieved in all cases, but rather, that a best (or near to best) design is selected from a finite set of possible designs that can be generated within an allotted time, given the available processing resources.

The design criteria can be defined by the user 160, or by another party and imported into the CAD program(s) 116. The design criteria can include an objective that drives the shape and/or topology evolution using an iterative numerical simulation process such as a generative design process. The design criteria can include physics objectives for the evolution of the structure of the 3D model. For example, an objective can correspond to a pressure drop or energy dissipation in the fluid domain corresponding to the physical structure. In some instances, the boundary conditions can be pressure, flow rate, flow velocity, etc. boundary conditions.

In topology optimization, the optimum distribution of material (such as fluid) can be determined by minimizing an objective function subject to design constraints (e.g., structural compliance with volume as a constraint). Density-based approaches discretize the volume of the part and assign a density to each discrete cell. Then, the densities are driven toward solid and empty while minimizing the objective(s) subject to the constraints. Boundary-based approaches instead track the shape of the external interface of the solid part and move the boundary such that the constraints are satisfied and the objective(s) are minimized, such as in a level-set method.

The shape and/or topology optimization program 116a can use any one of a level-set-based topology optimization or a density-based topology optimization. Various types of shape and/or topology modifying algorithms can be used. In some cases, the shape and/or topology optimization program 116a only modifies a shape of the 3D model 132. In some cases, the shape and/or topology optimization program 116a modifies both the shape and topology of the 3D model 132.

The user 160 or a program can select parameters 134B for the fluid in the fluid domain to control the flow regime of the fluid, i.e., laminar or turbulent flow. Parameters 134B can include flow rate, flow velocity, density, viscosity, or any combination. The user 160 or a program can select parameters 134C, such as velocity threshold and/or a target volume reduction, that can influence the resulting initial shape. The user or a program can also determine other settings for the shape and/or topology optimization program 116a, such as one or more design criteria 134D. The design criteria can include an objective that drives the shape and/or topology evolution using an iterative numerical simulation process. For example, a user or a program can set an objective corresponding to a pressure drop or energy dissipation in the fluid domain corresponding to the physical structure. The user or a program can also determine other settings 134E for the fluid simulation program 116b.

Once the shape and/or topology optimization process has finished and the user 160 is satisfied with the algorithmically designed model 132, the computer model 132 can be stored as a model document 130 and/or used to generate another representation of the model (e.g., toolpath specifications for a manufacturing process for the structure or portions thereof). This can be done upon request by the user 160, or in light of the user's request for another action, such as sending the computer model 132 to a manufacturing machine, e.g., additive manufacturing (AM) machine(s) and/or subtractive manufacturing (SM) machine(s) 170, or other manufacturing machinery, which can be directly connected to the computer 110, or connected via a network 140, as shown. This can involve a post-process carried out on the local computer 110 or externally, for example, based on invoking a cloud service running in the cloud, to further process the generated 3D model (e.g., based on considerations associated with the additive manufacturing process) and to export the 3D model to an electronic document from which to manufacture. Note that an electronic document (which for brevity will simply be referred to as a document) can be a file, but does not necessarily correspond to a file. A document may be stored in a portion of a file that holds other documents, in a single file dedicated to the document in question, or in multiple coordinated files. In addition, the user 160 can save or transmit the 3D model for later use. For example, the CAD program(s) 116 can store the document 130 that includes the algorithmically designed model 132.

The CAD program(s) 116 can provide a document 135 (e.g., having toolpath specifications of an appropriate format) to an AM and/or SM machine 170 to produce a physical structure corresponding to at least a portion of the algorithmically designed model 132. An AM machine 170 can employ one or more additive manufacturing techniques, such as granular techniques (e.g., Powder Bed Fusion (PBF), Selective Laser Sintering (SLS) and Direct Metal Laser Sintering (DMLS)) or extrusion techniques (e.g., Fused Filament Fabrication (FFF), metals deposition). In some cases, the AM machine 170 builds the physical structure directly, and in some cases, the AM machine 170 builds a mold for use in casting or forging the physical structure.

A SM machine 170 can be a Computer Numerical Control (CNC) milling machine, such as a multi-axis, multi-tool milling machine used in the manufacturing process. For example, the CAD program(s) 116 can generate CNC instructions for a machine tool system 170 that includes multiple tools (e.g., solid carbide round tools of different sizes and shapes, and insert tools of different sizes that receive metal inserts to create different cutting surfaces) useable for various machining operations. Thus, in some implementations, the CAD program(s) 116 can provide a corresponding document 135 (having toolpath specifications of an appropriate format, e.g., a CNC numerical control (NC) program) to the SM machine 170 for use in manufacturing the physical structure using various cutting tools, etc.

In addition, in some implementation, no physical manufacturing is involved. The systems and techniques described herein are applicable to any suitable 3D modelling software. Thus, in some implementations, the CAD program(s) 116 can be animation production program(s) that render the 3D model 132 to a document 165 of an appropriate format for visual display, such as by a digital projector 174 (e.g., a digital cinema package (DCP) 165 for movie distribution) or other high resolution display device. Other applications are also possible.

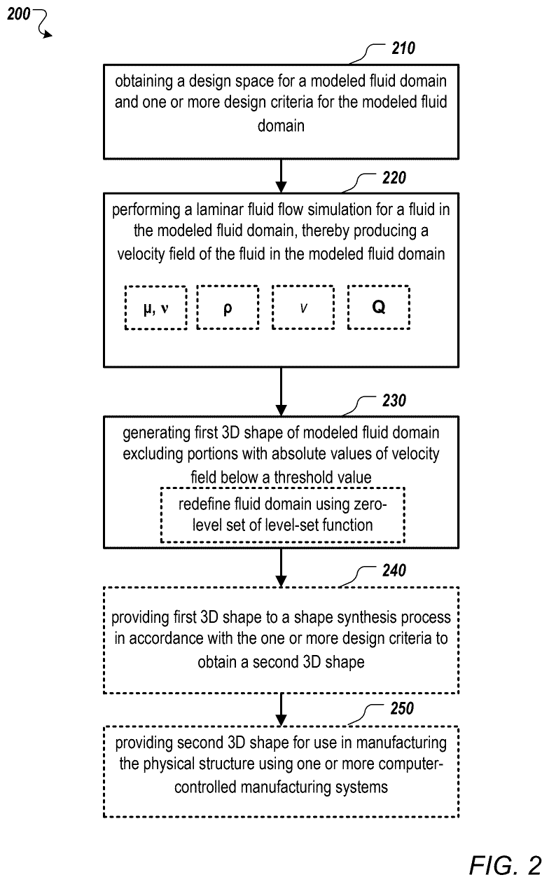

FIG. 2 is a flowchart of an example of a process 200 for shape and/or topology optimization. Process 200 can be used to optimize the three-dimensional shape of a modeled fluid domain for which a corresponding structure is to be manufactured. Process 200 can be used for shape synthesis of fluid domains corresponding to components of fluid systems such as pipes, hoses, valves, pumps, and/or hydraulic manifolds. Iterative shape synthesis (e.g., generative design) aimed at minimizing pressure drop or energy dissipation in a fluid system often involves many iterations of a physics solver that performs numerical fluid simulations, such as program 116b in FIG. 1 that simulates the evolution of turbulent flows in the fluid domain. In some cases, the optimization procedure also requires information about the sensitivities of the modeled fluid system to topological changes, which are obtained through an adjoint computation that is a separate calculation in addition to the fluid simulation. Both the fluid simulation itself and the adjoint computations involve high computational costs. Further, standard generative design processes typically require a starting design shape resembling the fluid domain to be optimized and that is modified in the generative design process in accordance with the design criteria (e.g., pressure drop minimization under a predetermined target volume reduction).

Contrary to standard generative design procedures, the process of FIG. 2 does not need an initial starting shape provided by the user since the initial starting shape for shape synthesis is generated based on a laminar flow simulation, as described in more detail below. The generated starting shape provides an optimal starting point for a shape synthesis process and eliminates numerous iterations of the physics solver and the adjoint solver to arrive at a final optimized shape for the design. This reduces processing power and memory usage. Further, the generated starting shape can lead to better final designs for fluid domains for turbulent flows that cannot be achieved when starting from a bulky domain or a domain provided by a user.

A design space for a modeled fluid domain for which a corresponding physical structure is to be manufactured and one or more design criteria for the modeled fluid domain can be obtained 210, e.g., by CAD program(s) 116, for use in producing a 3D model. The design space for the modeled fluid domain is the volume inside which the fluid domain is to be designed. The design space can include a bounding volume containing an initial specification of one or more outer shapes of the 3D topology for the fluid domain. The design space can include 3D model(s), designed in or loaded into the CAD program(s) 116, that serve as a sub-space of an optimization domain of a described shape and/or topology optimization process, and/or a set of input regions, e.g., keep-out regions where no geometry is to be generated and/or keep-in regions, used to specify boundary conditions for shape and/or topology optimization. The keep-in and/or keep-out regions can be, e.g., defined or selected by a user through a user interface, such as the UI 122. For example, the fluid domain can include keep-in regions such as an inlet region and/or an outlet region. Boundary conditions for fluid flow simulations can be specified at the inlet and/or outlet region.

The process of FIG. 2 does not need an initial starting shape provided by the user since the initial starting shape for shape synthesis is generated based on a laminar flow simulation. For example, the modeled fluid domain at 210 can be obtained, e.g., by CAD program(s) 116 as a bounding volume or a convex hull of the keep-in regions (e.g., the inlet region and/or outlet region).

At 220, a laminar fluid flow simulation for a fluid in the modeled fluid domain can be performed, e.g., by CAD program(s) 116, thereby producing a velocity field of the fluid in the modeled fluid domain. Since the flow is laminar, this simulation is not computationally expensive and can be performed quite fast.

Performing the laminar fluid flow simulation for the fluid in the modeled fluid domain can include setting values of fluid parameters such that the fluid flows under laminar flow. For example, any one of a first flow rate Q or flow velocity ν at the inlet region of the fluid domain, a first viscosity (dynamic or kinematic viscosity) for the fluid, or a first density ρ for the fluid or any combination such that the fluid flows under laminar flow. Laminar flow is usually described as flow corresponding to Reynolds numbers under a critical value.

Under laminar flow conditions, pressure is inversely proportional to velocity. Regions with low velocities correspond to high-pressure regions. In the laminar flow regime, the resulting velocity field is smooth and can have values close to zero in the vicinity of no-slip walls. Removing those regions leads to the removal of high-pressure regions that are detrimental for pressure/energy dissipation minimization.

At 230, a first three-dimensional shape of the modeled fluid domain can be generated, e.g., by CAD program(s) 116. Generating the first three-dimensional shape of the modeled fluid domain can include excluding from the modeled fluid domain portions of the fluid domain with absolute values of the obtained velocity field below a threshold value.

The first three-dimensional shape of the modeled fluid domain can be provided 240, e.g., by CAD program(s) 116, to a shape synthesis process (e.g., an iterative shape synthesis process) that modifies at least a shape of the fluid domain in accordance with the one or more design criteria to obtain a second three-dimensional shape of the modeled fluid domain. An iterative shape synthesis process modifies shape geometry and optionally both shape geometry and topology of the modelled object; thus, shape synthesis processes include automated modeling and generative design processes, including topology optimization processes, which can employ various boundary conditions.

Shape and/or topology optimization can be performed. Topology optimization includes modifying both a geometry of the 3D shape and a topology of the 3D shape (e.g., adding/removing holes or voids to modify the spatial properties of the surface, thus changing how shape elements are bounded and connected in the 3D model).

The one or more design criteria can include a target volume reduction for the second three-dimensional shape. The threshold value can be determined during the generating using a predetermined volume reduction cutoff based on the target volume reduction for the second three-dimensional shape. For example, the predetermined volume reduction cutoff VR_{cut} can be determined as VR_{cut}=f_{VR}*VR based on the target volume reduction VR, where f_{VR} is a dimensionless factor selected from the interval (0, 1). Once the predetermined volume reduction cutoff VR_{cut} is set, the threshold value can be determined. In some examples, a percentile of the velocity field magnitude equivalent to the predetermined volume reduction cutoff can be selected. For example, if the predetermined volume reduction cutoff VR_{cut} is set to 50%, a threshold value for the velocity field magnitude substantially equal to the median (50th percentile) of the velocity field magnitude can be selected. If the predetermined volume reduction cutoff is 30%, a threshold value for the velocity field magnitude substantially equal to the 30th percentile of the velocity field magnitude can be selected. If the fluid domain is discretized into discretization elements (e.g., voxels) of different sizes, the sizes of the discretization elements can be taken into account to determine the percentile of the velocity field magnitude corresponding to the predetermined volume reduction cutoff.

The threshold value can be a predetermined flow velocity cutoff v_{cut}. Portions of the fluid domain with absolute values of the obtained velocity field |v| below the predetermined flow velocity cutoff v_{cut} (i.e., |v|<v_{cut}) can be excluded to generate the first three-dimensional shape. Higher flow velocity cutoff values lead to higher amounts of material removal. In some examples, the flow velocity cutoff can be determined with respect to the maximum of the velocity field magnitude |vₘₐₓ| in the fluid domain. For example, the flow velocity cutoff can be determined as v_{cut}=f_{c}*|vₘₐₓ|, where f_{c} is an adimensional factor selected from the interval (0, 1). Decreasing the value of the factor f_{c} decreases the flow velocity cutoff v_{cut} and hence the amount of material removal. Increasing the value of the factor f_{c} increases the flow velocity cutoff v_{cut} and hence the amount of material removal, A value f_{c}=0 would give a threshold value v_{cut}=0 which would exclude portions with |v|<0, i.e., no portion of the fluid domain would be excluded. A value f_{c}=1 would give a threshold value v_{cut}==|vₘₐₓ| which would exclude portions with |v|<|vₘₐₓ|, i.e., no portion of the fluid domain would be excluded. For example, the flow velocity cutoff can be selected to be any value between 0.05 and 0.5 of the maximum velocity field magnitude. In some examples, the flow velocity cutoff can be selected to be any value between 0.01 and 0.4 of the maximum velocity field magnitude. For example, the cutoff can be 0.1 of the maximum of the velocity field magnitude.

Excluding from the modeled fluid domain the portions of the fluid domain with absolute values of the obtained velocity field below a threshold value can include redefining the fluid domain using a zero-level set of a level-set function, where the level-set function can be equal to a difference between the absolute values of the obtained velocity field and the threshold value.

The first 3D shape can be any suitable representation of the shape of the modeled fluid domain. For example, the first 3D shape can include a density-based representation. The boundary can be estimated using an iso-contour of the densities. In some examples, a boundary-based representation is used. For example, the first 3D shape can be a level-set representation ¢. A signed distance field is an example of such a level-set function $, where the zero-contour (zero-sublevel set) represents the shape boundary, positive values of the function correspond to points exterior to the material domain and quantify the distance between the point and the nearest domain surface, and negative values correspond to points interior to the fluid domain and quantify the distance between the point and the nearest domain surface.

The one or more design criteria can include minimizing pressure drop or energy dissipation in the fluid domain, The shape synthesis process can include setting second values for one or more fluid parameters such that the fluid flows under turbulent flow. For example, a second flow rate or flow velocity at the inlet region of the fluid domain, a second viscosity, a second density or any suitable combination such that the fluid flows under turbulent flow, and iteratively modifying, by the computer aided design program, the first three-dimensional shape of the modeled fluid domain in the design space in accordance with the one or more design criteria, to obtain the second three dimensional-shape of the fluid domain. The iterative shape synthesis process can include a generative design process for topology optimization.

The process of FIG. 2 can provide 250, e.g., by CAD program(s) 116, the second three-dimensional shape of the modeled fluid domain in the form of a computer model for use in manufacturing the physical structure using one or more computer-controlled manufacturing systems. For example, the second three-dimensional shape of the modeled fluid domain can be used to generate a 3D model of the three-dimensional shape of the physical structure.

The providing can involve sending or saving the 3D model to a permanent storage device for use in manufacturing the physical structure corresponding to the modeled fluid domain using manufacturing systems. In some implementations, the providing can involve generating, e.g., by CAD program(s) 116, toolpath specifications for computer-controlled manufacturing system(s) using the computer model, and manufacturing, e.g., by CAD program(s) 116, at least a portion of the 3D model corresponding to a portion of the physical structure to be manufactured with the computer-controlled manufacturing system(s) using toolpath specifications. In some implementations, the providing can include manufacturing a physical structure with a manufacturing machine using the toolpath specification generated, where the computer model can be a model of the physical structure that will be manufactured using a subtractive or an additive manufacturing process.

The process of FIG. 2 does not need an initial starting shape provided by the user since the initial starting shape is generated based on a laminar flow simulation. For example, the design space for the modeled fluid domain can include a bounding volume or a convex hull of the keep-in regions (e.g., the inlet region and/or outlet region). The generated starting shape provides an optimal starting point, e.g., for a generative design process, that eliminates numerous iterations of the physics solver and the adjoint solver to arrive at a final optimized shape for the design. Further, the generated starting shape can lead to better final designs that cannot be achieved when starting from a bulky domain or a domain provided by the user.

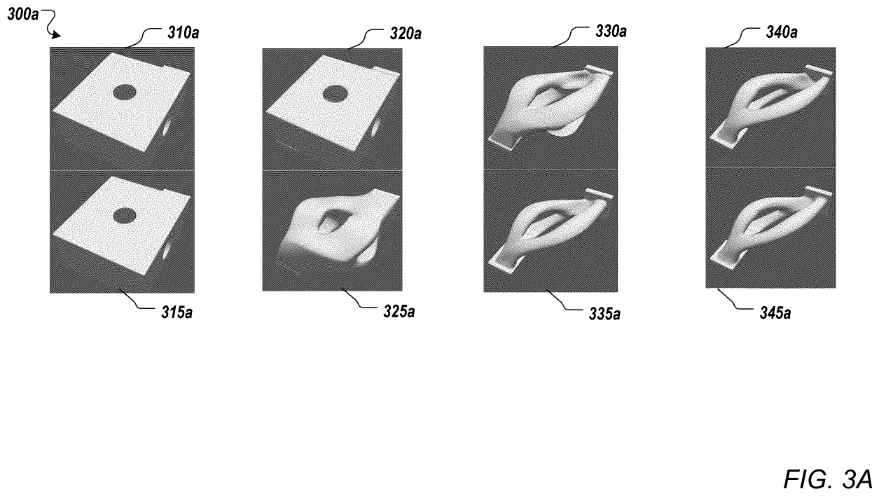

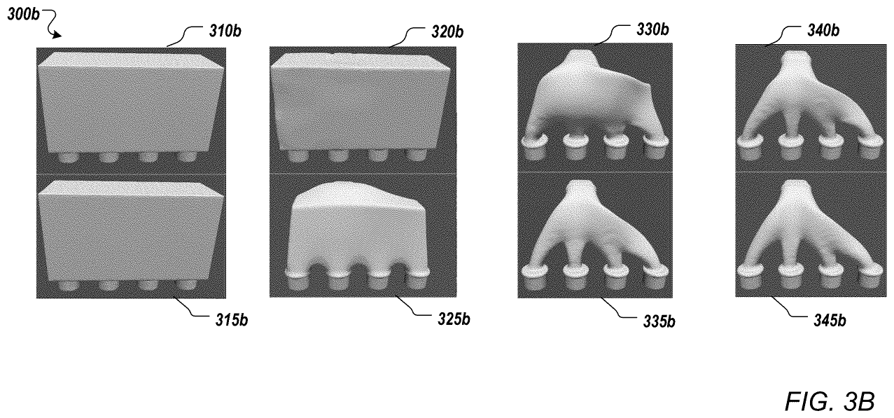

FIG. 3A shows an example of different stages of a process for topology optimization according to techniques described in this document (lower panels) in comparison to corresponding stages of a standard process for topology optimization (upper panels). The leftmost panels show the same modeled fluid domain 300a as obtained to be used for the standard process for topology optimization 310a and for the process for topology optimization 315a according to techniques described in this document. The panels in the second column show the initial 3D shape used as a starting point for the topology optimization process. In the case of the standard process, the starting point 320a is the fluid domain 300a as obtained. In the lower panel, the starting point 325a to the topology optimization process is the first three-dimensional shape of the modeled fluid domain generated by excluding from the model domain portions of the fluid domain with absolute values of a velocity field from a laminar fluid flow simulation that are below a threshold value.

The next panels show the same iteration of the topology optimization process for the standard process 330a and for the topology optimization process 335a using the provided first three-dimensional shape as described with reference to FIG. 2. The differences in the evolution are clearly visible. The topology generated by the standard process converges much slower and it is far from reaching the target volume reduction. The rightmost panels show the final stages for the standard process 340a and the process using the provided first three-dimensional shape 345a as described with reference to FIG. 2. The number of iterations shown is the same for both processes. The final shape achieved with the standard process has not achieved as much volume reduction after the same number of iterations. The topology optimization process 335a using the provided first three-dimensional shape as described with reference to FIG. 2 reduces memory usage during the shape changing iterations, e.g., for generative design, and also time to convergence.

FIG. 3B shows an example of different stages of a process for topology optimization according to techniques described in this document (lower panels) in comparison to corresponding stages of a standard process for topology optimization (upper panels). The leftmost panels show the same modeled fluid domain 300b as obtained to be used for the standard process for topology optimization 310b and for the process for topology optimization 315b according to techniques described in this document. The panels in the second column show the initial 3D shape used as a starting point for the topology optimization process. In the case of the standard process, the starting point 320b is the fluid domain 300b as obtained. In the lower panel, the starting point 325b to the topology optimization process is the first three-dimensional shape of the modeled fluid domain generated by excluding from the model domain portions of the fluid domain with absolute values of a velocity field from a laminar fluid flow simulation that are below a threshold value.

The next panels show the same iteration of the topology optimization process for the standard process 330b and for the topology optimization process 335b using the provided first three-dimensional shape as described with reference to FIG. 2. The differences in the evolution are clearly visible. The topology generated by the standard process converges much slower and it is far from reaching the target volume reduction. The rightmost panels show the final stages for the standard process 340b and the process using the provided first three-dimensional shape 345b as described with reference to FIG. 2. The number of iterations shown is the same for both processes. The final shape achieved with the standard process has not achieved as much volume reduction after the same number of iterations. The topology optimization process 335a using the provided first three-dimensional shape as described with reference to FIG. 2 reduces memory usage during the shape change iterations, e.g., for generative design, and also time to convergence.

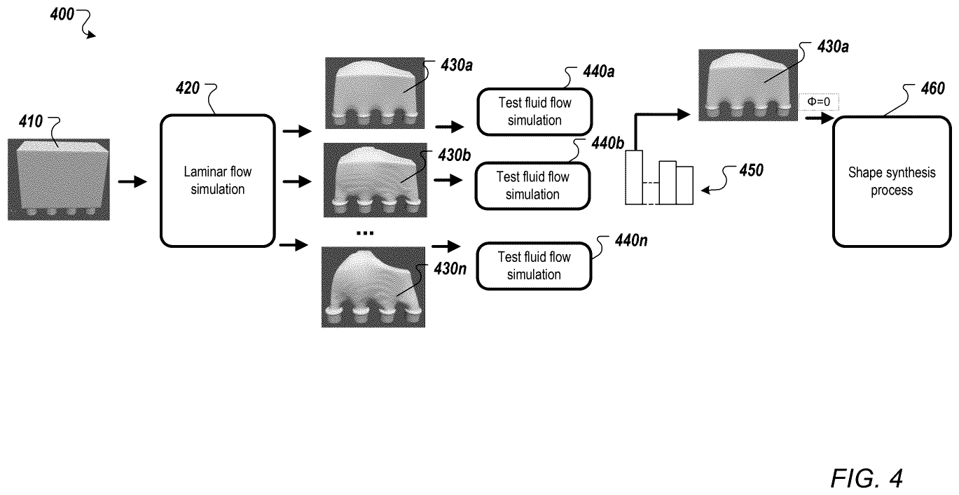

FIG. 4 is a schematic diagram of an example of a process 400 for shape synthesis, such as an iterative shape synthesis process that modifies shape geometry and optionally both shape geometry and topology. Process 400 can also obtain a design space for a modeled fluid domain 410, for which a corresponding physical structure is to be manufactured, and one or more design criteria for the modeled fluid domain. Process 400 can also perform a laminar fluid flow simulation 420 for a fluid in the modeled fluid domain, thereby producing a velocity field of the fluid in the modeled fluid domain.

However, in process 400, the threshold value can be a first threshold value. The excluding can generate a first test three-dimensional shape 430a. The generating can include excluding from the modelled fluid domain portions of the fluid domain with absolute values of the obtained velocity field below at least one second threshold value, thereby producing at least a second test three-dimensional shape 430b, 430n. Process 400 can include selecting one of the first test three-dimensional shape 430a and the at least one second test three-dimensional shape 430b, 430n as the first three-dimensional shape.

The selecting can include performing a test fluid flow simulation 440a, 440b, 440n for each of the first test shape 430a and the at least one second test shape 430b, 430n. Results of the test fluid flow simulations can be compared 450 against at least one performance design criterion to determine which of the first test shape 430a and the at least one second test shape 430b, 430n is selected as the first three-dimensional shape.

Performing the test fluid flow simulations 440a, 440b, 440n can include setting values for fluid parameters such that the fluid flows under turbulent flow. For example, a test flow rate or test flow velocity at the inlet region of the fluid domain, a test viscosity (kinematic or dynamic viscosity) of the fluid, a test density of the fluid or a combination thereof such that the fluid flows under turbulent flow. The at least one performance design criterion can include minimizing pressure drop or energy dissipation in the fluid domain. For example, the test shape that produced a lowest pressure drop or energy dissipation can be selected as the first three dimensional shape 430.

As described with reference to FIG. 2, the first three-dimensional shape 430a of the modeled fluid domain can be provided to a generative design process 460 for shape and/or topology optimization of the fluid domain in accordance with the one or more design criteria to obtain a second three-dimensional shape of the modeled fluid domain.

As described with reference to FIG. 2, the process of FIG. 4 can provide, e.g., by CAD program(s) 116, the second three-dimensional shape of the modeled fluid domain in the form of a computer model for use in manufacturing the physical structure using one or more computer-controlled manufacturing systems.

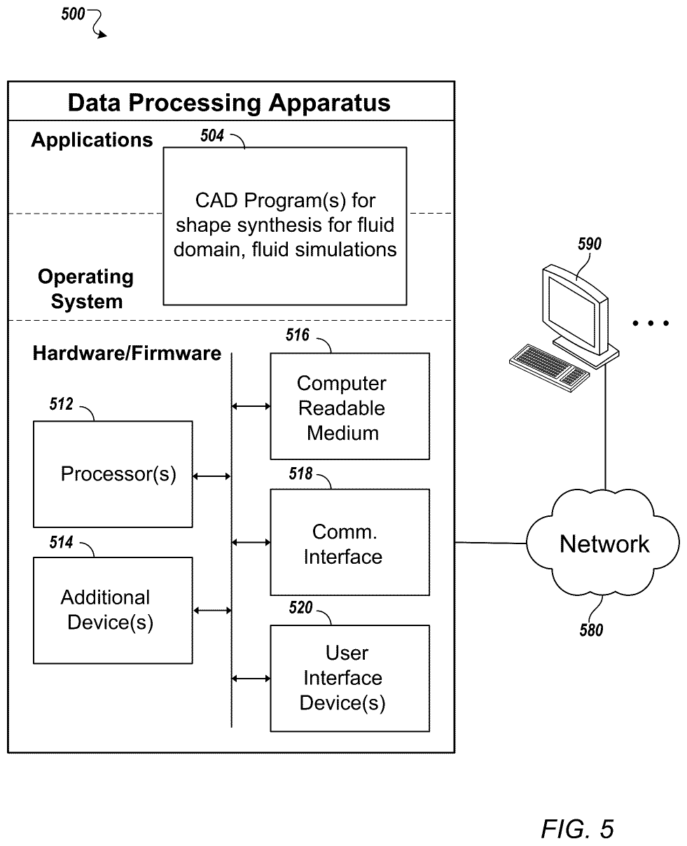

FIG. 5 is a schematic diagram of a data processing system including a data processing apparatus 500, which can be programmed as a client or as a server. The data processing apparatus 500 is connected with one or more computers 590 through a network 580. While only one computer is shown in FIG. 5 as the data processing apparatus 500, multiple computers can be used. The data processing apparatus 500 includes various software modules, which can be distributed between an applications layer and an operating system. These can include executable and/or interpretable software programs or libraries, including tools and services of one or more 3D modeling and/or simulation programs 504 that implement shape and/or topology optimization for a fluid domain using fluid flow simulations, as described above. Thus, the 3D modeling program(s) 504 can be CAD program(s) 504 (such as CAD program(s) 116) and can implement one or more methods for shape and/or topology optimization and physical (e.g., fluid flow) simulation operations (finite element analysis (FEA) or other). Further, the program(s) 504 can potentially implement manufacturing control operations (e.g., generating and/or applying toolpath specifications to effect manufacturing of designed objects). The number of software modules used can vary from one implementation to another. Moreover, the software modules can be distributed on one or more data processing apparatus connected by one or more computer networks or other suitable communication networks.

The data processing apparatus 500 also includes hardware or firmware devices including one or more processors 512, one or more additional devices 514, a computer readable medium 516, a communication interface 518, and one or more user interface devices 520. Each processor 512 is capable of processing instructions for execution within the data processing apparatus 500. In some implementations, the processor 512 is a single or multi-threaded processor. Each processor 512 is capable of processing instructions stored on the computer readable medium 516 or on a storage device such as one of the additional devices 514. The data processing apparatus 500 uses the communication interface 520 to communicate with one or more computers 590, for example, over the network 580. Examples of user interface devices 520 include a display, a camera, a speaker, a microphone, a tactile feedback device, a keyboard, a mouse, and VR and/or AR equipment. The data processing apparatus 500 can store instructions that implement operations associated with the program(s) described above, for example, on the computer readable medium 516 or one or more additional devices 514, for example, one or more of a hard disk device, an optical disk device, a tape device, and a solid state memory device.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a non-transitory computer-readable medium for execution by, or to control the operation of, data processing apparatus. The computer-readable medium can be a manufactured product, such as hard drive in a computer system or an optical disc sold through retail channels, or an embedded system. The computer-readable medium can be acquired separately and later encoded with the one or more modules of computer program instructions, e.g., after delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any suitable form of programming language, including compiled or interpreted languages, declarative or procedural languages, and it can be deployed in any suitable form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magnetooptical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of nonvolatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magnetooptical disks; and CDROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display) display device, an OLED (organic light emitting diode) display device, or another monitor, for displaying information to the user, and a keyboard and a pointing device, e.g., a mouse or a trackball, by which the user can provide input to the computer. Other kinds of devices can be used to provide for interaction with a user as well; for example, feedback provided to the user can be any suitable form of sensory feedback, e.g., visual feedback, auditory feedback, or tactile feedback; and input from the user can be received in any suitable form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a browser user interface through which a user can interact with an implementation of the subject matter described is this specification, or any combination of one or more such back-end, middleware, or front-end components. The components of the system can be interconnected by any suitable form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. In addition, actions recited in the claims can be performed in a different order and still achieve desirable results.

What is claimed is:

1. A method comprising:
obtaining, by a computer aided design program, a design space for a modeled fluid domain, for which a corresponding physical structure is to be manufactured, and one or more design criteria for the modeled fluid domain, wherein the fluid domain comprises an inlet region and an outlet region;
performing a laminar fluid flow simulation for a fluid in the modeled fluid domain, thereby producing a velocity field of the fluid in the modeled fluid domain;
generating a first three-dimensional shape of the modeled fluid domain, wherein generating the first three-dimensional shape of the modeled fluid domain comprises excluding from the modeled fluid domain portions of the fluid domain with absolute values of the obtained velocity field below a threshold value;
providing the first three-dimensional shape of the modeled fluid domain to an iterative shape synthesis process that modifies at least a shape geometry of the fluid domain in accordance with the one or more design criteria to obtain a second three-dimensional shape of the modeled fluid domain; and
providing, by the computer aided design program, the second three-dimensional shape of the modeled fluid domain for use in manufacturing the physical structure using one or more computer-controlled manufacturing systems.

2. The method of claim 1, wherein performing the laminar fluid flow simulation for the fluid in the modeled fluid domain comprises setting values for one or more fluid parameters, such that the fluid flows under laminar flow.

3. The method of claim 1, wherein the one or more design criteria comprises a target volume reduction for the second three-dimensional shape, and wherein the threshold value is determined during the generating using a predetermined volume reduction cutoff based on the target volume reduction for the second three-dimensional shape.

4. The method of claim 1, wherein the threshold value is a predetermined flow velocity cutoff.

5. The method of claim 1, wherein the threshold value is a first threshold value, the excluding generates a first test three-dimensional shape, the generating comprises excluding from the modelled fluid domain portions of the fluid domain with absolute values of the obtained velocity field below at least one second threshold value, thereby producing at least a second test three-dimensional shape, and wherein the method comprises
selecting one of the first test three-dimensional shape and the at least one second test three-dimensional shape as the first three-dimensional shape.

6. The method of claim 5, wherein the selecting comprises
performing a test fluid flow simulation for each of the first test shape and the at least one second test shape, and
comparing results of the test fluid flow simulations against at least one performance design criterion to determine which of the first test shape and the at least one second test shape is selected as the first three-dimensional shape.

7. The method of claim 6, wherein performing the test fluid flow simulation comprises setting i) a test flow rate or flow velocity at the inlet region of the fluid domain or ii) a test viscosity for the fluid, such that the fluid flows under turbulent flow.

8. The method of claim 6, wherein the at least one performance design criterion comprises minimizing pressure drop or energy dissipation in the fluid domain.

9. The method of claim 1, wherein excluding from the modeled fluid domain the portions of the fluid domain with absolute values of the obtained velocity field below a threshold value comprises redefining the fluid domain using a zero-level set of a level-set function, wherein the level-set function is equal to a difference between the absolute values of the obtained velocity field and the threshold value.

10. The method of claim 1, wherein the one or more design criteria comprises minimizing pressure drop or energy dissipation in the fluid domain, and wherein the iterative shape synthesis process comprises
setting second values for the one or more fluid parameters, such that the fluid flows under turbulent flow, and
iteratively modifying, by the computer aided design program, the first three-dimensional shape of the modeled fluid domain in the design space in accordance with the one or more design criteria, to obtain the second three dimensional-shape of the fluid domain.

11. The method of claim 1, wherein the iterative shape synthesis process comprises a generative design process for topology optimization.

12. A system comprising:
one or more processors; and
a computer-readable medium storing instructions of a computer aided design program that cause the one or more processors to perform operations comprising:
obtaining a design space for a modeled fluid domain, for which a corresponding physical structure is to be manufactured, and one or more design criteria for the modeled fluid domain, wherein the fluid domain comprises an inlet region and an outlet region;
performing a laminar fluid flow simulation for a fluid in the modeled fluid domain, thereby producing a velocity field of the fluid in the modeled fluid domain;
generating a first three-dimensional shape of the modeled fluid domain, wherein generating the first three-dimensional shape of the modeled fluid domain comprises excluding from the modeled fluid domain portions of the fluid domain with absolute values of the obtained velocity field below a threshold value;
providing the first three-dimensional shape of the modeled fluid domain to an iterative shape synthesis process that modifies at least a shape geometry of the fluid domain in accordance with the one or more design criteria to obtain a second three-dimensional shape of the modeled fluid domain; and
providing, by the computer aided design program, the second three-dimensional shape of the modeled fluid domain for use in manufacturing the physical structure using one or more computer-controlled manufacturing systems.

13. The system of claim 12, wherein performing the laminar fluid flow simulation for the fluid in the modeled fluid domain comprises setting first values for one or more fluid parameters, such that the fluid flows under laminar flow.

14. The system of claim 12, wherein the one or more design criteria comprises a target volume reduction for the second three-dimensional shape, and wherein the threshold value is determined during the generating using a predetermined volume reduction cutoff based on the target volume reduction for the second three-dimensional shape.

15. The system of claim 12, wherein the threshold value is a predetermined flow velocity cutoff.

16. The system of claim 12, wherein the threshold value is a first threshold value, the excluding generates a first test three-dimensional shape, the generating comprises excluding from the modelled fluid domain portions of the fluid domain with absolute values of the obtained velocity field below at least one second threshold value, thereby producing at least a second test three-dimensional shape, and wherein the operations comprise
selecting one of the first test three-dimensional shape and the at least one second test three-dimensional shape as the first three-dimensional shape.

17. The system of claim 16, wherein the selecting comprises
performing a test fluid flow simulation for each of the first test shape and the at least one second test shape, and
comparing results of the test fluid flow simulations against at least one performance design criterion to determine which of the first test shape and the at least one second test shape is selected as the first three-dimensional shape.

18. The system of claim 17, wherein the at least one performance design criterion comprises minimizing pressure drop or energy dissipation in the fluid domain.

19. The system of claim 12, wherein excluding from the modeled fluid domain the portions of the fluid domain with absolute values of the obtained velocity field below a threshold value comprises redefining the fluid domain using a zero-level set of a level-set function, wherein the level-set function is equal to a difference between the absolute values of the obtained velocity field and the threshold value.

20. The system of claim 12, wherein the one or more design criteria comprises minimizing pressure drop or energy dissipation in the fluid domain, and wherein the iterative shape synthesis process comprises
setting second values for the one or more fluid parameters, such that the fluid flows under turbulent flow, and
iteratively modifying the first three-dimensional shape of the modeled fluid domain in the design space in accordance with the one or more design criteria, to obtain the second three dimensional-shape of the fluid domain.
